(19) United States
(12) Patent Application Publication
(10) Pub. No.: US 2009/0009443 A1
(43) Pub. Date: Jan. 8, 2009

(54) Display Device

(75) Inventors: Hans-Helmut Bechtel, Roetgen (DE); Guofu Zhou, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/997,172

(22) PCT Filed: Jul. 26, 2006
(86) PCT No.: PCT/IB06/52555

§ 371 Date: Aug. 21, 2008

(30) Foreign Application Priority Data
Aug. 2, 2005 (EP) 05107110.8

(51) Int. Cl. G09G 3/32

(52) U.S. Cl. 345/83

(57) ABSTRACT

The present invention relates to a display device (5) comprising a display screen (8) for displaying information to a user of the device (5). The device (5) is operable in a first mode or in second mode. In the first mode a first illumination source (6) of the device (5) is operable to illuminate said screen (8) for displaying said information. In the second mode a second illumination source (7) disposed substantially in the vicinity of the screen (8) is operable to provide a second illumination of said screen (8) for displaying an image, a picture or a second information to the user.

### FIELD OF THE INVENTION

The present invention relates to a display device having a primary function of displaying information, for example television (TV), computer data etc.

### BACKGROUND OF THE INVENTION

Examples of display devices may be a television or PC monitor, which often merely has a primary function of displaying TV, a picture, computer data or other information through a screen of the device. This kind of display device is used for many purposes and both continuously and discontinuously depending on the circumstance in which it is used. When the display device is not used, it is occasionally switched off especially in order to save energy.

When the display device is not used, it may also be used for another purpose. An example of such other purpose of using a television is known from JP-2002136650 A. The television of JP-2002136650 A discloses a liquid crystal television set having a fluorescent tube, which tube is provided in the television set for an additional use of the television in the form a table lamp. The lamp function of the television set is provided by adjusting the light from the fluorescent tube into white light by letting the light through the color filter of R/G/B (Red/Green/Blue). The fluorescent tube is in this way reused in order to bring about a second function of the television. By using the same kind of light source, in this case a fluorescent tube, for both the primary and secondary functions no power is saved when the primary function of the television set is switched off, since the light source is just used for the secondary function—in this case as a lamp.

Additionally, this kind of display device is usually switched off when it is not used for the primary function of displaying information or as the function of a lamp. In the switched off state the display device appears as a black box and does not fit into the environment in most surroundings, such as in a living room or in a conference room. Even though the appearance is dull, the display device is switched off in order to save energy.

As the display screens of the display device are becoming larger and larger, the black and dull mode of the display device when turned off appears consequently increasingly dull and fits less and less into the surroundings of the display device.

Hence, an improved display device, which does not appear black and dull when turned off, will be increasingly advantageous, and in particular while being more efficient and/or less energy consuming without deteriorating the display device itself would be advantageous.

Display devices, such as a television or a PC monitor, may also comprise a LCD, also called Liquid Crystal Display, or OLED, also called Organic Light Emitting Diode, display to present information in different colors by using a plurality of pixels. Normally each pixel has subpixels for emitting the colors such as the primary color, of R (Red), G (Green) and B (Blue).

Moreover, in case of an LCD each pixel is illuminated by a backlight of the display. The colors, which are emitted by each subpixel, are controlled by one or more transistors whereby one subpixel is controlled to emit a particular color as function of time for displaying the information, which color may be one of the primary colors or some of them combined. A pixel is for these reasons divided into an area for emitting the colors and a non-emitting area in which the one or more transistors for controlling are situated. The backlighting is operable to illuminate each pixel whereby part of that light which illuminates the non-emitting areas is blocked, and, as a result, wasted. The size of the non-emitting area is determined by the size of the controlling part.

The brightness of the display screen is at present influenced by how much backlight is wasted on illuminating the non-emitting areas of the pixels and thereby how large the black non-emitting area is. Furthermore the brightness of the screen is influenced by the picture resolution, which determines the size of each pixel, and by how much energy is put into the backlighting of the display.

In order to improve the brightness of the display screen and at the same time save energy the black non-emitting areas have over the years been decreased so that less light of the backlighting is wasted on illuminating the non-emitting areas of the pixel. Nevertheless the brightness of the display screen is still capable of being improved and hence an improved display device, in which information displayed appears even brighter, would additionally be advantageous, and in particular an improved efficiency and/or reduced energy consumption would be advantageous.

### SUMMARY OF THE INVENTION

An objective of the present invention is to provide a display device, which appears more aesthetic when the device is not used for its primary purpose of displaying information or the like to the user, while reducing deterioration resulting from providing a more aesthetic appearance.

This objective and other advantages will be evident from below. The invention is defined by the independent claims. The dependent claims define advantageous embodiments.

By disposing a second illumination source substantially in the vicinity of the screen, a second illumination for displaying an image, a picture or information, for example a pattern, a photo, a logo or slogan or the like, to the user is obtained. Hereby a display device fitting more into its surroundings is obtained than for example a dull black box.

A display using a second illumination source for displaying one image, one picture or one view of information in stead of the first illumination source for displaying moving images, pictures or information consumes furthermore less energy since more units using energy is needed for displaying moving images, pictures or information than just for displaying one image, one picture or one view of information.

By turning on the second illumination source of the display for displaying an image, a picture or a photo when the first illumination source of the display device is turned off, the display device is transformed into an aesthetic creation and does no longer appears dull. The display device as an aesthetic creation may take the shape of a painting or a photo in a frame. The second illumination source of the display device may furthermore be used to provide a background illumination of the room in which the display device is present; the display may then provide a cozy and home-like atmosphere. The display device in the form of providing a cozy and home-like atmosphere may be used in the room instead of a dimmer or the like. By turning the display device into an aesthetic creation and/or a pleasant background lighting such a display device may then replace the aforementioned objects by just one device capable of providing the desired functions.

Furthermore, by turning on the second illumination source of the display device for displaying particular information, such as a logo or minor information in a static or in a dynamic fashion, when the first illumination source of the display device is turned off, the display device is then displaying only this particular information. The particular information may be from a user-defined source, for example PC, DVD or other medium. The second illumination source enables that the display device is used for a second purpose as mentioned above instead of having to use a separate second display device for showing this particular information. Additionally, the display device does no longer appear black and dull when the first illumination source is turned off in order to save energy.

Furthermore, the second illumination source of the display device may be turned on once the display device has registered that the display device has not been used for a short period of time in stead of the well known “screen saver”. The display device is thereby transformed into an aesthetic creation while not used, for example during a presentation, a lecture, or the display device might even display a joke or a comic strip to keep the receivers of the presentation or lecture awake.

Additionally, the second illumination source, with its associated units to enable its operation, may consume less energy than the first illumination source. It is hereby obtained that the display device is transformed into an aesthetic creation and simultaneously consuming less energy, when the first illumination source is turned off than when the first illumination source displays information. The aesthetic creation is hereby obtained with lower energy consumption compared to the normal display operation and without deterioration of the display itself.

The second illumination source may be disposed substantially peripherally to the display screen of the device. By disposing the second illumination source peripherally to the display screen, the screen is illuminated in a simple manner. Such a second illumination source can be easily incorporated into an existing display device without extensive construction changes.

The second illumination source may be situated behind or in front of the display screen. The second illumination source may for example be disposed directly on the front side of the screen or directly on the backside of the screen. The second illumination source may be incorporated by adding a layer onto the screen, which layer illuminates when exposed to electricity. A second illumination source is hereby obtained, which is easily incorporated in the existing design of a display device without making the display device larger or much more complicated in design, manufacture and construction. Additionally, the second illumination source may be disposed in the periphery behind or in front of the screen whereby an illumination of the screen in order to transform the display device into an aesthetic creation is obtained.

Additionally, the display device may comprise a source control unit for controlling which illumination source is operable to illuminate said screen. Furthermore, the second illumination source may be operable to be turned on in parts, which parts may be turned on one after the other, when the first illumination source is turned off. It is hereby obtained to transform a display device into lively aesthetic creation in that each part itself is an image displayed in turns. The display device is then for the same reason as above using less energy when the second illumination source is turned on and the first illumination source is turned off.

Another objective of the present invention is to provide an improved display device in which information displayed on the display screen of the device appears brighter without increasing the size of each pixel in the display device.

Another aspect of the present invention has for its object to provide an improved display device in which information displayed on the screen under high ambient light illumination light levels appears with higher contrast.

This objective and other advantages which will be evident from below are obtained by a display device comprising a display screen for displaying information to a user of the device, wherein the display screen may have at least one pixel with a blocking area, said device being operable in a first, second or third mode, wherein in said first or third mode a first illumination source of the device is operable to illuminate said screen for displaying said information, wherein in said second or third mode a second illumination source is disposed in the blocking area of the pixel to illuminate said screen.

By disposing a second illumination source in the blocking area of the pixel to illuminate said screen, the brightness of the displayed information in the display device is improved without increasing the size of each pixel in the display screen. The second illumination source enhances in the third mode the first illumination source in that both the first illumination source and the second illumination source in the third mode illuminates the screen, whereby the brightness of the displayed information is enhanced. Additionally, the blocking area of the pixel is used for another purpose besides making room for the pixel control unit, such as a transistor. Thereby, the picture resolution is not decreased in order to increase the brightness of the displayed information.

Furthermore, it is obtained that the second illumination source in the second mode may be used as an additional lightning when the first illumination source is turned off. The second illumination source may be used as additional lightning for many purposes, for example for illuminate a picture in order to present an off-state creation. When the television or PC monitor is turned off it appears dull and does not fit into the surroundings of the room in which the television or PC monitor is placed. By turning on the second illumination source in order to illuminate an image or the like, it is then possible to make the display screen into an aesthetic creation in stead of the dull black state appearance.

In yet another aspect of the present invention, the second illumination source in the third mode may emit substantially a comparable flux of light as the first illumination source or more in order to enhance the first illumination source. An enhanced brightness of the information or image displayed to the user is hereby obtained without increasing the size of each pixel in the display device.

Advantageously, the second illuminating source may according to another aspect of the present invention be arranged to be switched on simultaneously as the first illumination source.

In another aspect of the present invention, the display device may be operable in the third mode in which the second illumination source is operable to provide illumination in the same color or in a brighter color as the illuminated pixel from the first illumination source. A total brighter color and higher contrast is hereby obtained.

The second illumination source is turned to the same color as the pixel that is illuminated by the first illumination source, to largely enhance the color brightness and contract—improve image quality. The color of the second illumination source may thus be individually selected/generated for every pixel according to the image information (color) to be displayed on the pixel.

Advantageously, the second illumination source in the third mode may emit substantially a flux of light in ratio of 5:1 to the first illumination source, preferably in the ratio of 3:1, according to another aspect of the present invention.

Furthermore, the display device may have a pixel control unit for controlling which color the pixel is emitting, and that the second illumination source may be situated between the pixel control unit and the pixel. The second illumination source may then act as a blocking area when the first illumination source is turned on and a second process of providing a blocking area may be omitted.

Additionally, the display device may have a pixel control unit for controlling which color the pixel is emitting, and that the pixel control unit may be situated at a back side of the pixel closest to the first illumination source and that second illumination source is situated in front of the pixel. It is likewise obtained that the second illumination source then may act as a blocking area when the first illumination source is turned on and a second process of providing a blocking area may be omitted. Furthermore, the light emitted from the second illumination source is not interrupted by being directed through the pixel whereby some of the light may be diverted and wasted.

In another aspect of the present invention, the second illumination source may be an organic or inorganic light emitting area. By being an organic light emitting area the second illumination source may comprise an OLED (organic light emitting diode) or a PLED polymer based light diode), which takes up a very small space compared to other types of lightning. The same advantage is obtained if the second illumination source comprises an inorganic light-emitting source. Furthermore, when the second illumination source comprises an inorganic film EL structure, high production temperature will not cause a problem as for the organic light emitting area.

In yet another aspect of the present invention, the organic or inorganic light emitting area may be applied to the pixel to form the blocking area by a deposition process, a printing process, a filtering process or a spraying process in the form of a film. By applying the organic or inorganic light emitting area by one of these processes, it is possible to provide the blocking area in an easy and precise manner.

Additionally, the light emitting area according to an aspect of the present invention may comprise a injection layer, a transport layer, a light emitting layer, a blocking layer, an electron transport layer or a second electrode layer or a combination thereof.

Furthermore, the light emitting area may according to the present invention comprise a inorganic layer, such as ZnS, Mn, Th or a combination thereof. The inorganic layer when comprising one of ZnS, Mn, Th may when subjected to a certain voltage emit light of substantially one color and when the layer comprises a combination thereof different colors in the same pixel may be obtained. It is also possible to provide one pixel with one of ZnS, Mn, Th and another pixel with another of ZnS, Mn, Th. It is hereby possible to provide an image of different colors and thereby make the display device into a decoration, which may fit, into the surroundings of the device.

Additionally, the light emitting area may according to the present invention comprise a polymer based organic light emitting diode (PLED), which is easy to adhere to the pixel and thereby very production friendly.

Another aspect of the present invention relates to a method of displaying information to a user of the aforementioned display device, comprising the step of switching on the first illumination source, wherein the method further comprises the step of switching on a second illumination source disposed in the blocking area of a pixel in the display screen to illuminate said screen.

Yet another aspect of the invention relates to a method comprising the steps of switching off the first illumination source when switching on the second illumination source.

### BRIEF DESCRIPTION OF THE FIGURES

The present invention will in the following be described by way of example only with reference to the accompanying drawings, in which:

FIG. 1 shows an embodiment of a display device with second illumination sources,

FIG. 2 shows another embodiment of a display device with second illumination sources,

FIGS. 3, 4, 5 and 6 show schematically possible locations of the second illumination source in the display device,

FIG. 7 shows schematically a drawing of a pixel having window areas for emitting the primary colors of Red, Green and Blue,

FIG. 8 shows schematically a drawing of a pixel having a second illumination source in the blocking area, and

FIG. 9 shows a typical structure of a display device in which pixels are situated.

### DETAILED DESCRIPTION OF THE INVENTION

The same reference numerals in different Figs. represent the same or similar items.

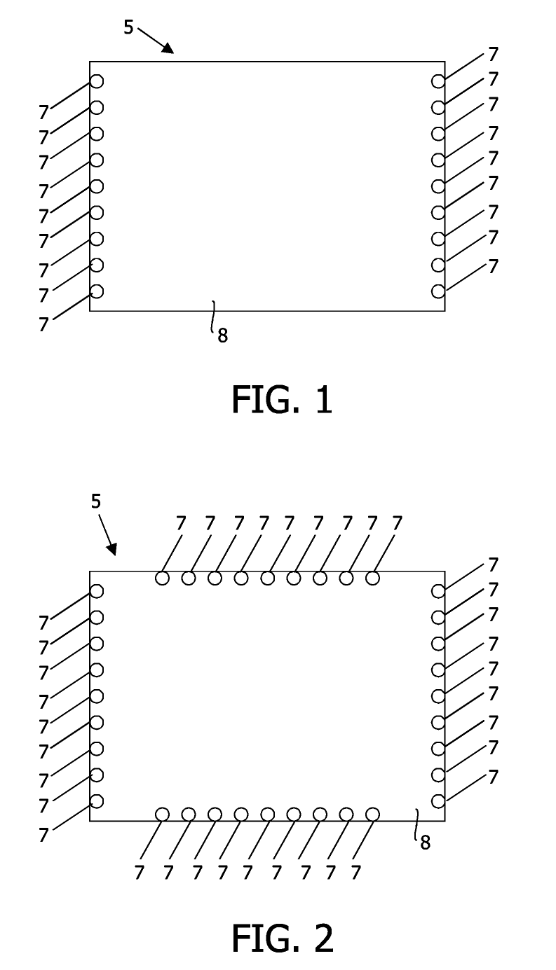

An embodiment of a display device 5 according to the invention for displaying information by means of a first illumination source to a user of the display device is shown in FIG. 1. The display device 5 is shown as having second illumination sources 7 at the edges of the display screen at two sides of a display screen 8 of the display device 5. When the display device is not used for displaying information to a user, the first illumination source is turned off in order to save energy. Then the second illumination sources of the display device are turned on in order to illuminate an image, a photo, a picture or other information appearing in the display screen. The second illumination sources illuminate particles of the screen which illumination is reflected in order to provide the image or the like. The second illumination sources 7 may also illuminate different layers in the screen in order to provide different colors. The second illumination source 7 may furthermore be a neon lamp illuminating only some parts of the screen 8 in order to provide an image or the like. Hereby the display device is transformed into a decoration, which device then fits into its surroundings.

In FIG. 2 the display device is shown as having the second illumination sources 7 in both sides of the screen 8 and in the top and bottom of the screen 8. The second illumination sources 7 may in other embodiments of the present invention be placed in a different way for example in the corners of the display screen 8.

The second illumination sources are in FIGS. 1 and 2 shown as being situated in front of the display screen but may as well be situated beside and/or behind the display screen. Illuminating particles of the screen situated on the backside of the screen may be performed in a similar way as described above.

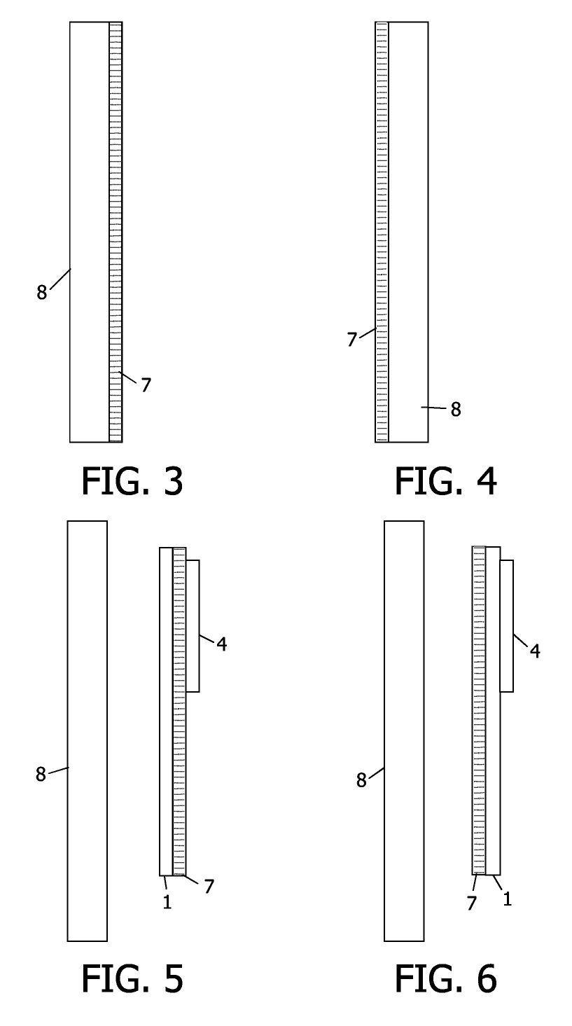

The second illumination source 7 may be disposed directly on the backside of the screen, as shown in FIG. 3, or directly on the front of the screen, as shown in FIG. 4. The left side is the front side in FIGS. 3 and 4. The second illumination source 7 is in this aspect added as a layer onto the display screen 8, which layer enables the illumination of the screen 8 when the layer is exposed to electricity. The layer comprises different particles or different layers of particles. This layer, when exposed to electricity, may generate different colors and/or may generate a single color, which may be converted into various colors in combination with a color filter forming part of the screen 8, whereby an image or the like can be created. A second illumination source 7 in the form of a layer is hereby obtained, which second illumination source 7 is easily incorporated in the existing design of display device 5 without making the display device larger or much more complicated in design, manufacture and construction. The display device, is by turning on this second illumination source 7, transformed into an aesthetic creation in a simple manner. The second illumination source 7 itself or together with one or more units simultaneously consumes less energy than when the first illumination source displays detailed moving pictures. When the first illumination source is turned on, the display device 5 may display very detailed moving pictures and when the second illumination source 7 is turned on the display device 5 may display substantially one particular image, photo, picture or one view of information. When the display device is displaying moving pictures by means of the first illumination source, the display device makes use of a number of other units using more energy than the unit or units needed to display only one image by means of the second illumination source 7. The display device is consequently using less energy when the second illumination source 7 is used to transform the display device 5 into an aesthetic creation than when the first illumination source is used for displaying all sorts of information or moving pictures.

The second illumination source 7 may be incorporated at the front of internal components 1 as shown in FIG. 6, or, as shown in FIG. 5, at the backside of these internal components 1 as long as the second illumination is capable of illuminating the screen from this position. This is the case in some transparent components 1 for providing the first illumination for example a filter for providing different colors. The left side of the components 1 in FIGS. 5 and 6 is the front side. A pixel control unit 4 may be present at the backside of the component 1 as will be elucidated later on. Furthermore, in the case of providing the second illumination source 7 in front of internal components 1 the source is placed in spaces not used for other purposes.

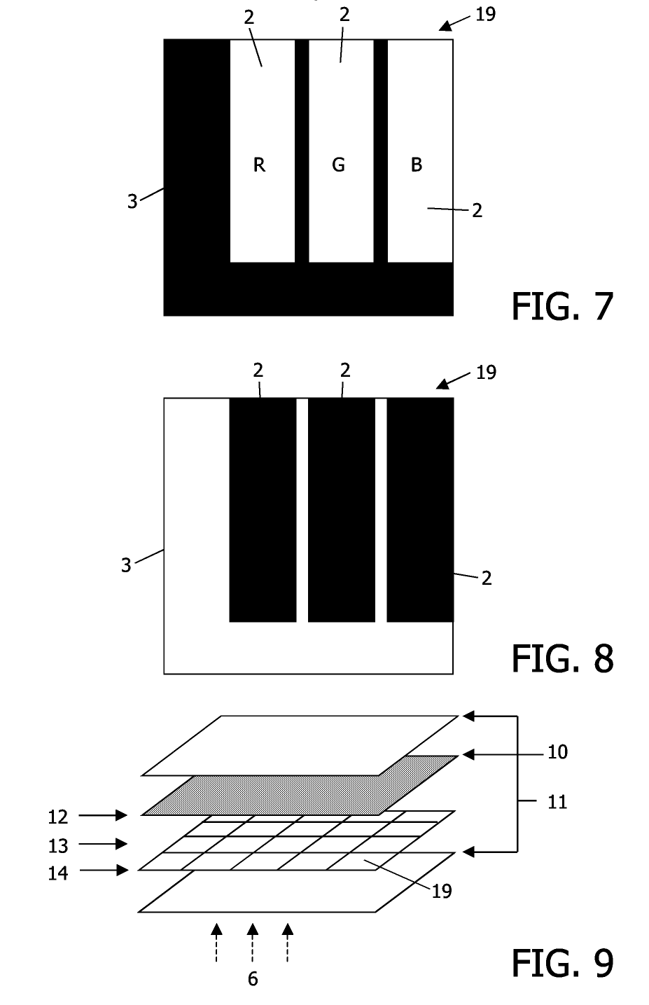

The display device 5 has a display panel comprising pixels 19 each controlled by at least one pixel control unit comprising one or more transistors. FIG. 7 shows a pixel 19 of an embodiment of a display device according to the present invention. The pixel 19 is shown in a first mode when a first illumination source 6 (not shown) is turned on and a second illumination source 7 (not shown) turned off. Thereby three window areas 2 for emitting the primary colors of R (Red), G (Green) and B (Blue) are illuminated and a blocking area 3 is shown as a dark area in relation to the window areas 2. The window areas 2 are also called subpixels.

The pixel 19 in FIG. 7 is shown as observed by a user from a front side of the display device. A pixel control unit 4 for controlling how much of each color is to be emitted is disposed on the backside of the pixel 1 and this pixel control unit 4 is therefore not shown in FIG. 7. The pixel control unit 4 comprises among others a transistor and forms the blocking area of the pixel 19. The pixel control unit 4 hinders and blocks the emitted light of the first illumination source 6 from passing the pixel 19. To ensure that light from the first illumination source 6 only passes through the window areas 2 and to improve the color separation between different colors R,G, and B, the blocking area 3 is defined precisely by a blocking layer applied onto the pixel 19. The blocking area 3 is a little larger than the size of the pixel control unit 4 in order to control the exact amount of light emitted through the window areas 2, namely the size of each window area.

The pixel 19 shown in FIG. 8 shows the situation in a second mode where the second illumination source 7 is active and the first illumination source 6 is turned off, whereby the aforementioned window areas 2 are no longer operable to transmit light from the first illumination source 6 and are shown as black areas. The second illumination source 7 is in this mode illuminating the display screen 8 for displaying for example an image in order to change a dull black display device into a decoration. In this way the device fits well in its surrounding.

Additionally or alternatively, in a third mode both the first illumination source 6 and the second illumination source 7 may be turned on simultaneously. When both illumination sources are turned on, the second illumination source 7 generates a bright color in order to enhance the image or information displayed using the first illumination source 6. By the wording bright color is meant substantially a flux of light in the order of 20% of the level of the first illumination source or more in order to enhance the first illumination source. Furthermore, the second illumination source 7 may illuminate one or more window areas for emitting the primary colors R, G, B, which are also receiving light from the first illumination source 6. This enhances the image or information displayed using the first illumination source 6.

The component 1 as shown in FIG. 5 and FIG. 6 may comprise or may be formed by a pixel 19 (not shown).

The second illumination source 7 may be provided directly on such pixel 1 of the display device 5. The second illumination source 7 may be placed on the backside of the pixel in relation to the display screen 8, as shown in FIG. 5, between the pixel 1 and the pixel control unit 4. The second illumination source 7 may alternatively be placed on the front side of the pixel 19 in relation to the display screen 8, as shown in FIG. 6.

In both aspects shown in FIGS. 5 and 6, the first illumination source is illuminating the pixel 19 from behind the pixel 19 towards the screen 8, whereby the pixel control unit 4 is blocking some of the light in a blocking area.

In an embodiment, the second illumination source 7 serves as the blocking layer thereby covering an area which is about the size of the pixel control unit 4 or a little larger than this size. The second illumination source 7 may be applied onto the back side or the front side of the pixel 19 similar as shown in FIGS. 5 and 6, in the form of an organic light emitting area comprising Organic Light Emitting Diodes, also called OLED, such as small-molecule OLED, also called smOLED, or polymer based OLED, also called PLED. The OLEDs may be applied onto the pixel by a vacuum deposition process, a printing process, a filtering process or a spraying process, whereby the OLEDs form the light emitting area. The OLEDs may be addressable individually, in groups, or all together at the same time in order to provide the second illumination source 7.

Such OLEDs comprises as a minimum a substrate, a bottom electrode, commonly configured to be an anode, a top electrode, commonly configured as a cathode, spaced from bottom electrode, and a light emitting layer. At least one electrode is (semi-) transparent for light generated in the light emitting layer of the OLED. In one embodiment the cathode comprises a semi-transparant layer, for example 35 nm of BA, and a hightly refective layer, for example 100 nm Aluminum. The anode comprises a transparent conductive layer for example ITO, also called indium-tin oxide. This construction of an OLED is known as the so-called “Black Cathode” technology of the company Luxell (SID 94 Digest page 140) and is also called an OLED “Black Matrix”. The Oled can also comprise a hole-injecting layer, a hole-transporting layer, an electron-transporting layer, and an electron-injecting layer.

The substrate can be an organic solid, an inorganic solid, or a combination of organic and inorganic solids. Typical substrate materials include glass, plastic, metal, ceramic, semiconductor, metal oxide, semiconductor oxide, semiconductor nitride, or combinations thereof. The substrate can be a homogeneous mixture of materials, a composite of materials, or multiple layers of materials. The substrate can be an OLED substrate, namely a substrate commonly used for preparing OLED devices, for example active-matrix low-temperature polysilicon or amorphous-silicon TFT substrate. The substrate can either be light transmissive or opaque, depending on the intended direction of light emission. Suitable materials for use in a hole-injecting layer are, but are not limited to, porphyrinic compounds, plasma-deposited fluorocarbon polymers, and inorganic oxides including vanadium oxide, also called VOx, molybdenum oxide, also called MoOx, nickel oxide, also called NiOx, and so forth.

The hole transporting layer may comprise naphthalene-diphenyl-benzidine, also called NPB. Examples of electron injecting materials may comprise alkaline or alkaline earth metals, alkali halide salts, such as LiF or alkaline or alkaline earth metal doped organic layers.

The OLED “Black Matrix” works as a perfect Black Matrix when turned off. When this second illumination source is turned on, for example when a voltage of 3-8 V is applied to the electrodes, the OLED “Black Matrix” emits light.

Any emission color of the OLED “Black Matrix” can be realized either monochrome over the whole display screen 8 or segmented between different areas. The aforementioned cathodes and anodes may be addressed and interconnected in various ways to allow uniform illumination or selection of different areas or patterns in creating an image for a decoration purpose, as mentioned above.

In an embodiment, the second illumination source 7 in the form of the aforementioned OLED “Black Matrix” 7 is situated at the front side of the pixel 19 and the pixel control unit 4 is situated at the back side of the pixel 1, as shown in FIG. 6. The emitted light from this OLED is then emitted directly towards the display screen 8 and not through the pixel 1. The OLED “Black Matrix” 7 still has the function of being the blocking area when the second illumination source 7, here the OLED “Black Matrix” 7, is turned off.

In another embodiment, the OLED “Black Matrix” 7 may be provided on the backside of the display screen 8 as shown in FIG. 3 or at the front of the display screen 8 as shown in FIG. 4.

In a further embodiment, the second illumination source 7 may in stead of a so-called OLED “Black Matrix” comprise an inorganic film ElectroLuminescence (EL) structure, which structure can emit light when a voltage of 3-300 V, such as 100-250V is applied to the electrodes. The inorganic film EL structure can function as the OLED and can be realized either monochrome over the whole display screen 8 or segmented between different areas. The cathodes and anodes of the inorganic film EL structure may be addressed and interconnected in various ways to allow uniform illumination or selection of different areas or patterns in creating an image for a decoration purpose, as mentioned above.

In a further embodiment, the window areas for emitting the colors may be other colors than the primary colors as mentioned above.

Furthermore, these window areas for emitting the colors may of the present invention be OLEDs, PLEDs or made of an inorganic film EL structure, so that the first illumination source is situated in the pixel 19 and not behind in the form of backlighting. Both the first illumination source 6 and the second illumination source 7 may be selected from the same group comprising OLEDs, PLEDs or made of an inorganic film ElectroLuminescence (EL) structure.

The present invention can be applied on both LCD displays and on all kinds of OLED displays, such as small-molecule OLED, polymer based OLED, bottom emission OLED, top emission OLED, R/G/B primary OLED and white emitting OLED with color filters.

The second illumination source may in all embodiments be in the form of a point, a line or a plane light source. Furthermore, the display device 5 may be a direct view TV or a PC monitor regardless the exact display screen 8 used, comprising a CRT, also called cathode ray tube, a PDP, also called Plasma Display Panel, an LCD panel or an OLED panel or others.

For Plasma Display Panels the temperature during manufacturing is very high and in this case an inorganic Light Emitting Diode, also called LED dice, may advantageously be implemented to provide the second illumination source. This inorganic LED dice can easily be implemented within the barrier stripes of the PDP or even within its phosphor channels. LED dices can furthermore be selected to emit any color and depending on the number of dices and optical coupling to light guiding layers, the resulting illumination of the PDP can have any desired shape of an image.

In FIG. 9, a display device is shown comprising a polarizing filter 11. The device further comprises a TFT panel 14 of pixel 19 located beneath a liquid crystal 13. The liquid crystal 13 is located beneath a color filter panel 12 and transparent electrodes 10 (not shown). The broken arrows are shown to illustrate the light originating from the second illumination source 6.

The first illumination source is operable in a first mode in which the first illumination source is either turned on or turned off. Likewise is the second illumination source operable in a second mode in which the second illumination source is either turned on or turned off. The second illumination source may be operable to be turned on when the first illumination source is turned off and likewise may the first illumination source may be operable to be turned on when the second illumination source is turned off. The device may in the third mode be operable so that both the first and the second illumination source are turned either on or off. When both are turned on one of the sources is then executing the most illumination and will therefore determine for what may appear at the screen. The determining source may then be supported by the other source for displaying the image, picture, photo, information or data to the user.

The display device is operable in a first or third mode, when the first illumination source is turned on to display any kind of images, pictures, photos, information or data, which images, pictures, photos, information or data may displayed in a random order in order to create moving images, pictures, photos, information or data.

The wording blocking area is defined as being the area of a pixel where components for controlling the pixel are blocking the light illuminated from the first illumination source. This blocking area may also be called a non-emitting area of the pixel in the case where the second illumination source is not placed on the pixel.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1. A display device comprising a display screen for displaying information to a user of the device, said device comprising pixels with sub-pixels and a blocking area, said device being operable in a first mode or in second mode, wherein in said first mode a first illumination source of the device is operable to illuminate said screen for displaying said information by illuminating the sub-pixels or by arranging the first illumination source in the sub-pixels, wherein the blocking area comprises a pixel control unit, and in said second mode a second illumination source disposed substantially in the vicinity of the screen is operable to provide a second illumination of said screen for displaying an image, a picture or a second information to the user, wherein the second illumination source is arranged for illuminating the blocking area being reflective or wherein the second, illumination source is disposed in the blocking area of the pixel.

2. The display device as claimed in claim 1, wherein the second illuminating source is arranged to be switched on when the first illumination source is switched off.

3. The display device as claimed in claim 1, wherein the second illumination source, arranged for illuminating the blocking area, is disposed peripherally to the display screen of the device.

4. The display device as claimed in claim 1, wherein the second illumination source is situated behind or in front of the display screen.

5. The display device as claimed in claim 1, wherein the display device further comprises a source control unit for controlling which illumination source is operable to illuminate said screen.

6. The display device as claimed in claim 1, wherein the display device is operable in a third mode in which both the first and the second illuminating source are operable to provide illumination simultaneously.

7. (canceled)

8. The display device as claimed in claim 1, wherein the pixel comprises sub-pixels, each being adapted for providing light of a respective color, and wherein the second illumination source in the blocking area of the pixel emits light of a color similar to the respective colors for increasing in the third mode the total flux of light of this color as result of the first and second illumination source or of a color differing from each of the respective colors for increasing in the third mode the color gamut of the display device.

9. The display device as claimed in claim 1, wherein the second illumination source comprises at least one organic or inorganic light emitting diode.

10. The display device as claimed in claim 9, wherein the organic or inorganic light emitting diode is applied to the pixel by a deposition process, a printing process, a filtering process or a spraying process in the form of a film.

11. The display device as claimed in claim 9, wherein the light emitting diode comprises a injection layer, transport layer, a light emitting layer, a blocking layer, an electron transport layer or a second electrode layer.

12. The display device as claimed in claim 9, wherein the light emitting diode comprises an inorganic layer.

13. The display device as claimed in claim 9, wherein the light emitting diode is a polymer based organic light emitting diode.

14. A method of displaying on a display screen of a display device information to a user of the display device, said device comprising pixels with sub-pixels and a blocking area, the device comprising a first illumination source and a second illumination source disposed substantially in the vicinity of the screen, the method comprising:
switching on the first illumination source in a first mode for displaying said information by illuminating the sub-pixels or by arranging the first illumination source in the sub-pixels, wherein the blocking area comprises a pixel control unit, and
switching on the second illumination source in a second mode for displaying an image, a picture or second information to the user, wherein the second illumination source is arranged for illuminating the blocking area being reflective or wherein the second illumination source is disposed in the blocking area of the pixel.

15. The method as claimed in claim 14, further comprising
switching off the first illumination source when switching on the second illumination source.

16. The method as claimed in claim 15, further comprising
switching on parts of the second illumination source in turns.

17. The display device as claimed in claim 1, wherein the second illumination source serves as a blocking layer for blocking light in the blocking area.
